(19) United States
(12) Patent Application Publication
(10) Pub. No.: US 2008/0071968 A1
(43) Pub. Date: Mar. 20, 2008

(54) Method of managing blocks fo flash memory suitable for flexible correspondence between logic block and physical block

(75) Inventors: Ming-Jen Liang, Chutung Town (TW); Chu-Cheng Liang, Chutung Town (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: PHISON ELECTRONICS CORP., Chutung Town (TW)

(21) Appl. No.: 11/522,377

(22) Filed: Sep. 18, 2006

(51) Int. Cl. G06F 12/00

(52) U.S. Cl. 711/103

(57) ABSTRACT

A method of managing blocks of a flash memory device suitable for a flexible correspondence between logic blocks and physical blocks of the flash memory device is provided. First, a sum of good physical blocks and defective physical blocks is calculated. Next, the good physical blocks and the defective physical blocks are distributed into a number of predetermined sectors of a flash memory, wherein each predetermined sector has a predetermined number of temporary blocks in order to equalize the sum of logic blocks and the temporary blocks with the physical blocks in each predetermined sector. The distribution information is recorded into a good physical block. When executing to initialize said flash memory, a control chip locates and reads the block where the distribution information is stored and stores the distribution information into a SRAM of said control chip to create a block correspondence chart in the predetermined sector to manage said flash memory.

### BACKGROUND OF THE INVENTION

1. Field of the Invention

The present invention relates to a method of managing blocks of a flash memory suitable for a flexible correspondence between a logic block and a physical block. More particularly, the present invention relates to a method of managing blocks of a flash memory such that a correspondence between the logic block and the physical block is implemented regardless of accumulation of defective blocks in one or a plurality of sectors in the flash memory in order to enable the flash memory to function properly.

2. Description of the Related Art

The development of a nonvolatile memory began from a mask-ROM, OTP ROM, EPROM, EEPROM to the present flash memory. The flash memory, besides possessing the advantages of the non-volatile memory, also has the advantage of high reading/storing speed and does not consume any power for storing data. These advantages have made the flash memory an indispensable memory device, and the flash memory has become the fast-developed product in the semiconductor industry. Some manufacturers combined the control chip with the flash memory to develop a new storage device, for example, memory stick and memory card. The flash memory has the advantages of low power consumption, nonvolatile, shock proof, high density storage capacity, and the like, and does not require any motor, magnetic pick-up head or other components. Thus, it is possible to minimize the size of the flash memory that meet the requirement of the latest electronic products, such as digital camera, MP3 and PDA. Thus, the application of flash memory in the storage media has become very popular. With the progressive development of technology, the flash memory, which has several physical blocks, has larger storage capacity to satisfy the user's need.

The storage capacity of the present flash memory is has been developing up to 512 MB, wherein such flash memory has 4096 physical blocks. Because the number of the SRAM on the control chip is limited, therefore the flash memory has to manage the blocks therein sector by sector, and then manage the full range after swapping. Each sector is managed equally, for instance, the flash memory with 4096 blocks is divided into four sectors and each sector has 1024 blocks. This managing method is simple, the flash memory has good and defective physical blocks evenly distributed, and the logic block and the physical block correspond to each other in a certain proportion. If the defective physical blocks are accumulated unevenly in one or few sectors in the flash memory, and since the logic blocks correspond with the respective physical blocks on a one-to-one basis, thus there are no free block available in the sector for replacement for writing the information into the sector, and the flash memory is unable to store any new information. Accordingly, the user has to buy another new storage device for storing new information.

Taking the flash memory with the 512 MB storage capacity as an example, there are 4096 physical blocks and 3968 logic blocks. Assuming that the blocks are defined into 4 predetermined sectors, there would be 80 defective physical blocks evenly distributed in the flash memory. Upon calculation, the number of the logic blocks and the physical blocks in a certain proportion, there are 1024 physical blocks and 992 logic blocks, and there are 1004 good physical blocks and 12 temporary blocks. In this case, the flash memory can be managed normally, and the flash memory can function normally. But if the defective physical blocks are accumulated in one or a plurality of sectors, the good physical blocks in these sectors may be less than 992, and therefore the number of the good physical blocks would be smaller the sum of the logic blocks and the temporary blocks, and therefore would be insufficient for correspondence with the logic blocks and the temporary blocks.

Therefore, it is highly desirable not to have a one-to-one correspondence of the logic blocks with the physical blocks in each sector for effectively and efficiently managing the flash memory when the defective physical blocks accumulate in one or a plurality of sectors.

### SUMMARY OF THE INVENTION

According to an aspect of the present invention, the number of good and defective physical blocks in the flash memory is determined in advance. Next, these blocks are distributed according to the number of predetermined sectors therein, wherein each predetermined sector has a predetermined number of temporary blocks so as to equalize the number of the logic blocks and the temporary blocks with the physical blocks. Thus, the accumulation of the defective physical blocks in one of the defined sectors within a flash memory or in one of the defined sectors in one or plural flash memories may be effectively avoided and the logic blocks and the physical blocks may be managed more effectively and efficiently. Accordingly, there will not be too many invalid defective physical blocks and the flash memory can be managed more flexibly.

### BRIEF DESCRIPTION OF THE DRAWING

FIG. 1 is a view showing a block calculation method of the present invention.

FIG. 2 is a view a block management of the present invention.

FIG. 3 is a flowchart of a method of initializing of the flash memory of the present invention.

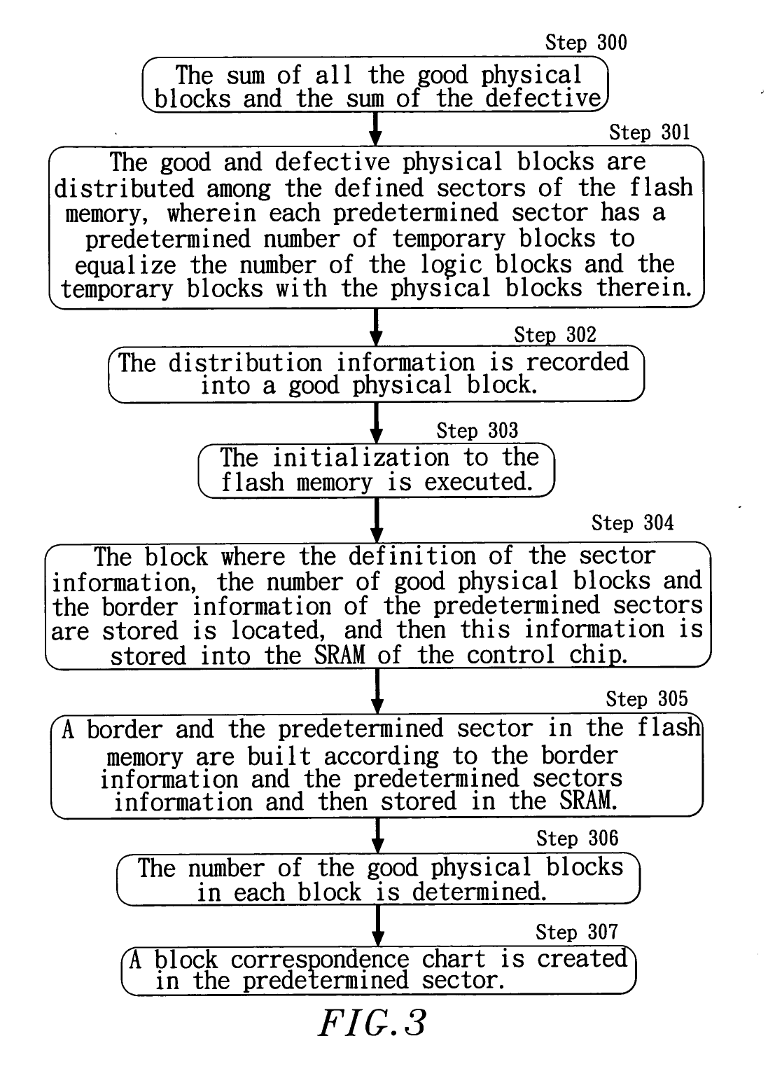

### DETAIL DESCRIPTION OF THE EMBODIMENTS

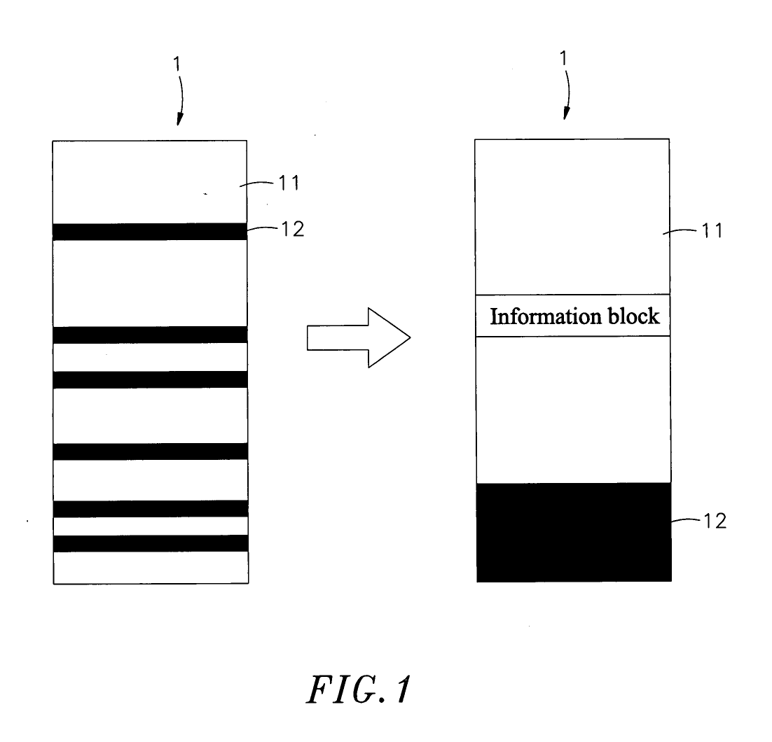

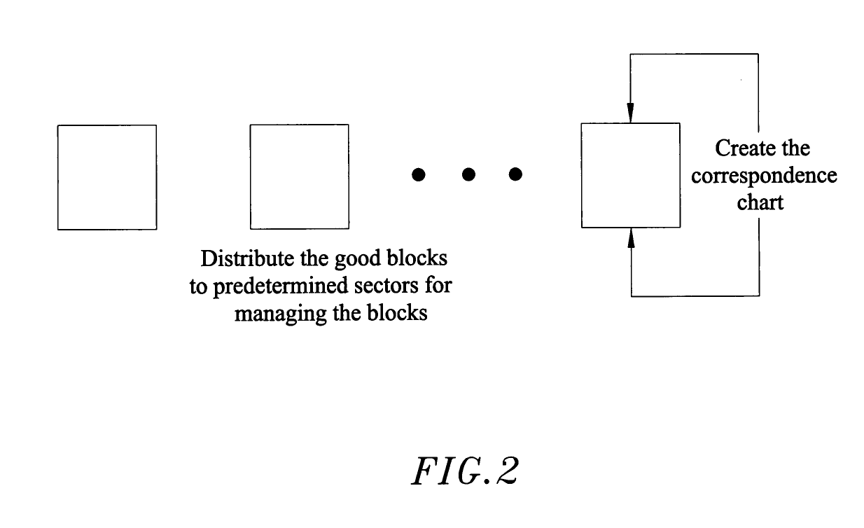

Referring to FIG. 1 and 2, a flash memory 1 comprises a control chip (not shown) for calculating the sum of the good physical blocks 11 and the sum of the defective physical blocks 12 in order to distribute them among the predetermined sectors of the flash memory 1. Each predetermined sector has a predetermined number of temporary blocks so as to equalize the number of the logic blocks and the temporary blocks with the defective physical blocks 12 therein. The distribution information including the number of the predetermined sectors, the number of the good physical blocks 11 and a border information is stored in one of the good physical blocks 11. When the flash memory 1 is in the initialization stage, the control chip locates the good physical block 11 in which the distribution information including the number of predetermined sectors, the number of good physical blocks 11 and the border information of the predetermined sectors is stored and then reads the distribution information from the good physical block 11 and then stores this information into the SRAM of the chip. When initiating each defined sector, the control chip creates a correspondence chart of the block in the sector corresponding to the information stored in the SRAM to enable the logic blocks correspondence with the defective physical blocks 12. Accordingly, regardless whether or not the defective physical blocks 12 accumulate in one or a plurality of sectors, the flash memory 1 can still be managed effectively.

According to the above method, for example, the flash memory 1 with 4096 blocks may be divided into 4 predetermined sectors with each predetermined sector having 1024 physical blocks, wherein when there are 80 defective physical blocks 12 evenly distributed in the flash memory 1, each predetermined sector will have 1004 good physical blocks 11, 992 logic blocks and 12 temporary blocks. Thus, there will be more number of good physical blocks 11 than the logic blocks so as to enable the flash memory 1 to function normally.

When the defective physical blocks 12 accumulate in one sector, based on the principle that the number of the logic blocks is non-proportional, such that each predetermined sector has 1024 physical blocks, 944 good physical blocks 11 and 932 logic blocks. Accordingly, there are 12 temporary blocks, 1024 good physical blocks 11 and 1012 logic blocks in another sector to maintain 12 temporary blocks. As shown in the Figure, there is greater number of the good physical blocks 11 than the logic blocks. Thus, there are sufficient number of temporary blocks, and the flash memory 1 can function normally.

Hereinafter, the procedure of initialization of the flash memory 1 with reference to FIG. 1, 2 and 3 as follows.

At step 300, the sum of all the good physical blocks 11 and the sum of the defective physical blocks 12 are calculated.

At step 301, the good and defective physical blocks 11, 12 are distributed among the defined sectors of the flash memory 1, wherein each predetermined sector has a predetermined number of temporary blocks to equalize the number of the logic blocks and the temporary blocks with the physical blocks therein.

At step 302, the distribution information is recorded into a good physical block 11.

At step 303, the initialization to the flash memory 1 is executed.

At step 304, the block where the definition of the sector information, the number of good physical blocks 11 and the border information of the predetermined sectors are stored is located, and then this information is stored into the SRAM of the control chip.

At step 305, a border and the predetermined sector in the flash memory 1 are built according to the border information and the predetermined sectors information stored in the SRAM.

At step 306, the number of the good physical blocks 11 in each block is determined.

At step 307, a block correspondence chart is created in the predetermined sector.

As can be seen from above description that when the flash memory 1 has too many defective physical blocks 12, the number of the good physical blocks 11 and the number of the logic blocks can be adjusted according to the non-proportionality principle by including a predetermined number of temporary blocks (for example 12 temporary blocks) in order to manage the flexibly flash memory.

Accordingly, the method of managing blocks of the flash memory of the present invention can overcome the disadvantages of the conventional art. According to the present invention, the sum of number of the good and defective blocks is calculated and then the blocks are distributed in the predetermined sectors in the flash memory, wherein each predetermined sector has a predetermined number of temporary blocks in order to equalize the number of the logic blocks and the temporary blocks with the physical blocks in the predetermined sector. This information is stored into the SRAM of the control chip so that the control chip can create a block correspondence chart in the predetermined sector during execution to initialize the flash memory. Accordingly, each predetermined sector has the number of the logic blocks non-proportional to the number of physical blocks, wherein the temporary blocks may be utilized to effectively operate the flash memory. Thus, the logic blocks and the physical blocks can be managed according to the method of the present invention regardless of whether the defective physical blocks accumulate in one or a plurality of predetermined sectors, or in one or a plurality of sectors of one or a plurality of flash memories. Thus, there will not be many invalid physical blocks.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A method of managing blocks of a flash memory device suitable for a flexible correspondence between logic blocks and physical blocks of the flash memory device, comprising:
calculating a sum of good physical blocks and a sum of defective physical blocks; and
distributing the good physical blocks and the defective physical blocks into a number of predetermined sectors of a flash memory, wherein each predetermined sector has a predetermined number of temporary blocks in order to equalize the sum of said logic blocks and said temporary blocks with said physical blocks in each predetermined sector, the distribution information is recorded into a good physical block, and wherein when executing to initialize said flash memory, a control chip locates said block where said distribution information is stored and reads said distribution information and then stores said distribution information into a SRAM of said control chip so as to create a block correspondence chart in said predetermined sector to manage said flash memory.

2. The method of managing blocks of a flash memory device suitable for a flexible correspondence between logic blocks and physical blocks of the flash memory device according to claim 1, wherein said distribution information comprises a number of predetermined sectors, a number of good physical blocks in each predetermined sector and a boarder information.

3. The method of managing blocks of a flash memory device suitable for a flexible correspondence between logic blocks and physical blocks of the flash memory device according to claim 1, wherein said flash memory device comprises a single or a plurality of flash memories.
